(19) United States
(12) Patent Application Publication
(10) Pub. No.: US 2015/0291096 A1
(43) Pub. Date: Oct. 15, 2015

(54) DRIVING RECORDER CAPABLE OF ASSISTING IN CORRECTING SHOOTING POSTURE AND CORRECTION METHOD OF THE SAME

(71) Applicant: PAPAGO INC., Taipei City (TW)

(72) Inventors: Liang-Yi CHIEN, Taipei City (TW); Fang-Chu CHOU, Taipei City (TW); Chun-Kai CHANG, Taipei City (TW)

(21) Appl. No.: 14/509,165

(22) Filed: Oct. 8, 2014

(30) Foreign Application Priority Data
Apr. 9, 2014 (TW) 103113028

(51) Int. Cl. B60R 1/00; H04N 7/18

(52) U.S. Cl. CPC B60R 1/00; H04N 7/183

(57) ABSTRACT

A driving recorder capable of assisting in correcting a shooting posture and a correction method of the same are provided. The driving recorder includes: an image capturing unit, a gravity sensing unit, a storage unit and a processing unit. The gravity sensing unit senses an orientation of the driving recorder and generates angle information; the storage unit stores shooting angle logic tables to correspond to a variety of orientations of the driving recorder; and the processing unit selects a corresponding shooting angle logic table from the storage unit according to the angle information, and generates an actuation signal, so as to adjust a shooting angle of the image capturing unit.

### CROSS-REFERENCE TO RELATED APPLICATION

This application claims the benefit of Taiwan Patent Application No. 103113028, filed on Apr. 9, 2014, which is hereby incorporated by reference for all purposes as if fully set forth herein.

### BACKGROUND

1. Technical Field

The present disclosure relates to a driving recorder capable of assisting in correcting a shooting posture and a correction method of the same, and more particularly to a driving recorder capable of assisting in correcting a shooting posture and capable of adjusting a shooting angle by using a gravity sensor, and a correction method of the same.

2. Related Art

It is increasingly common to install a driving recorder in a vehicle in recent years, and the driving recorder is an audio and video recording system which is used for recording road conditions during a travel period of a vehicle. By means of the driving recorder, once a traffic accident occurs, images shot by the driving recorder even in combination with recorded contents can be used to assist in determining causes of the accident and attribution of responsibility.

A conventional driving recorder substantially includes a lens, an image processor, a memory device and other elements or devices that are disposed in a casing, where the lens is used for shooting images; the image processor is used for processing conversion between analog signals and digital signals; and the memory device is an electronic device for storing the shot images and recording sound.

Based on considerations of a wide shooting angle, the convenience in operation, and other factors, an external driving recorder is generally disposed on a driving console. However, the disposing the driving recorder on the driving console not only affects the sight of the driver to cause traffic safety issues, but also affects the appearance; even, vibrations occurring in driving may cause shifts of photographic lens, and the lens angle needs to be adjusted frequently. Moreover, during on-road driving, the shooting angle of the photographic lens of the driving recorder may be changed due to road conditions, and the photographic lens cannot capture images at expected orientations, so the angle of the photographic lens needs to be adjusted whenever the driving recorder shakes. On the other hand, if the driving recorder is formed of a photographic lens and other components that are separated from the photographic lens, a transmission line for connecting the lens and the other components also affects the appearance as the line is exposed.

### SUMMARY

The present invention provides a driving recorder capable of assisting in correcting a shooting posture and a correction method of the same, in which a gravity sensor is used to assist in correcting an image shooting posture without assistance of a screen, thereby further reducing the cost of the screen in the driving recorder and achieving the purpose of reducing the size of the driving recorder.

The present invention provides a driving recorder capable of assisting in correcting a shooting posture, which comprises an image capturing unit, a gravity sensing unit, a storage unit and a processing unit. The gravity sensing unit senses an orientation of the driving recorder and generates angle information; the storage unit stores shooting angle logic tables to correspond to a variety of orientations of the driving recorder; the processing unit selects a corresponding shooting angle logic table from the storage unit according to the angle information, and generates an actuation signal to adjust a shooting angle of the image capturing unit.

In an embodiment of the present invention, the image capturing unit and the gravity sensing unit have a coordinate correspondence therebetween.

In an embodiment of the present invention, the image capturing unit further comprises a photosensitive module, and the photosensitive module adjusts a direction according to data obtained by the gravity sensing unit after measurement.

In an embodiment of the present invention, the shooting angle of the image capturing unit is parallel with a road surface.

The present invention provides a correction method of a driving recorder capable of assisting in correcting a shooting posture, which is applicable to a driving recorder, where the driving recorder at least comprises a storage unit for storing shooting angle logic tables to correspond to a variety of orientations of the driving recorder. The correction method comprises the following steps: first, sensing, by a gravity sensing unit, an orientation of the driving recorder and generating angle information; selecting, by a processing unit, a corresponding shooting angle logic table from the storage unit according to the angle information and generating an actuation signal; and finally, adjusting a shooting angle of an image capturing unit according to the actuation signal.

In an embodiment of the present invention, the step of adjusting a shooting angle of an image capturing unit according to the actuation signal further comprises: adjusting a shooting angle of a photosensitive module of the image capturing unit according to the actuation signal.

In an embodiment of the present invention, the correction method further comprises: adjusting a direction of the photosensitive module according to data obtained by the gravity sensing unit after measurement.

In an embodiment of the present invention, the correction method further comprises: comparing the image capturing unit with the gravity sensing unit to obtain a coordinate correspondence between the image capturing unit and the gravity sensing unit.

According to the present invention, a gravity sensor is used to assist in correcting an image shooting posture without assistance of a screen, which can further reduce the cost of the screen in a driving recorder and reduce the size of the driving recorder, so that the driving recorder does not hinder a view of a driver during driving.

### BRIEF DESCRIPTION OF THE DRAWINGS

The disclosure will become more fully understood from the detailed description given herein below for illustration only, and thus are not limitative of the disclosure, and wherein:

FIG. 1 is a block diagram of elements of a driving recorder of the present invention;

FIG. 2 is a schematic diagram showing a coordinate correspondence between an image capturing unit and a gravity sensing unit of the present invention;

FIG. 3 is a schematic diagram of a first embodiment of the present invention;

FIG. 4 is a schematic diagram showing shooting angle deflection of an image capturing unit in FIG. 3; and

FIG. 5 and FIG. 6 are flowcharts of a shooting posture correction method of a driving recorder.

### DETAILED DESCRIPTION

In order to make the aforementioned objectives and advantages of the present invention more comprehensible, embodiments accompanied with figures are described in detail below.

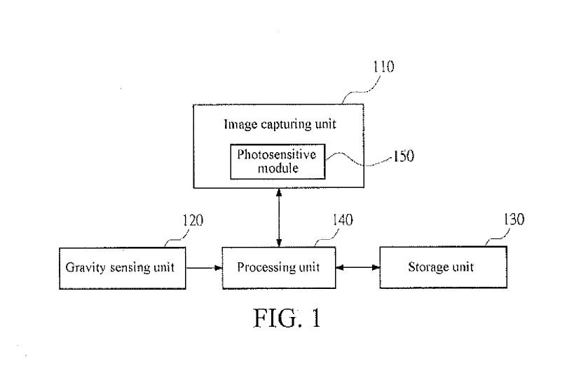

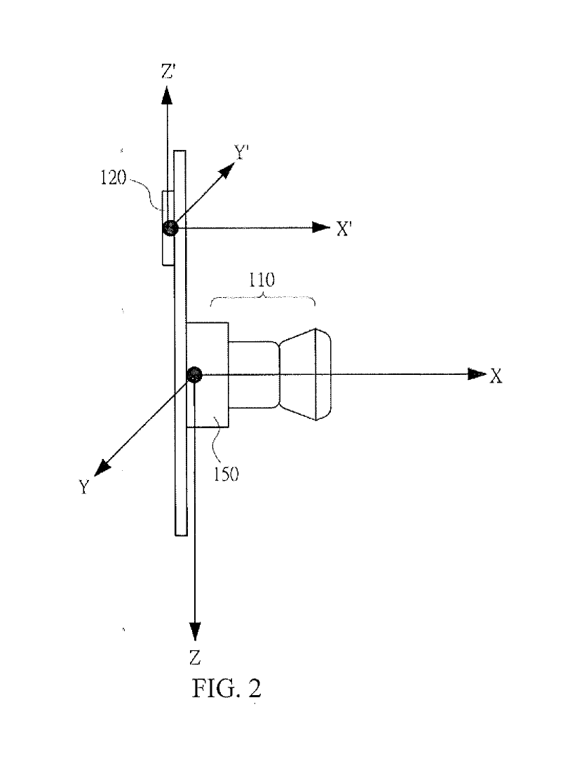

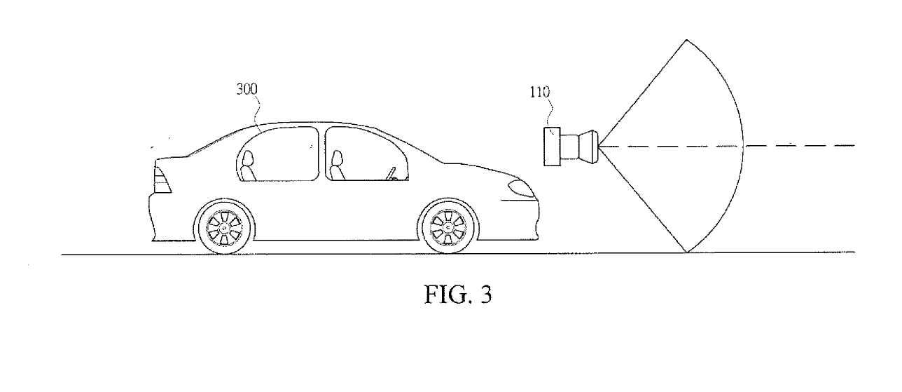

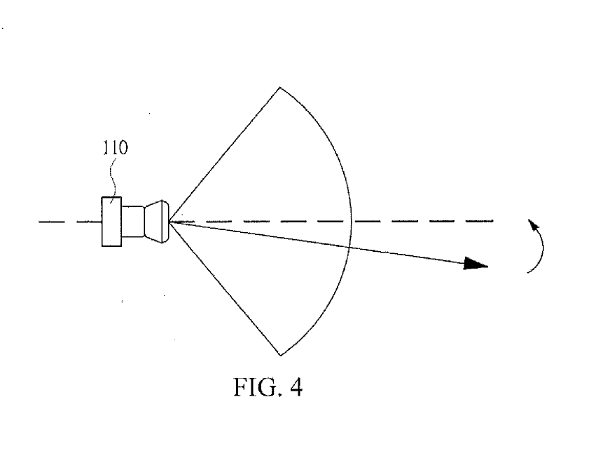

Referring to FIG. 1 to FIG. 4 together, FIG. 1 is a block diagram of elements of a driving recorder of the present invention; FIG. 2 is a schematic diagram showing a coordinate correspondence between an image capturing unit and a gravity sensing unit of the present invention; FIG. 3 is a schematic diagram of a first embodiment of the present invention; and FIG. 4 is a schematic diagram showing shooting angle deflection of an image capturing unit in FIG. 3. In FIG. 1, a driving recorder capable of assisting in correcting a shooting posture includes an image capturing unit 110, a gravity sensing unit 120, a storage unit 130 and a processing unit 140. The image capturing unit 110 further includes a photosensitive module 150.

The gravity sensing unit 120 and the image capturing unit 110 have a coordinate correspondence therebetween (as shown in FIG. 2), so as to sense an orientation of the driving recorder and generate angle information. The storage unit 130 stores shooting angle logic tables to correspond to a variety of orientations of the driving recorder.

During travelling of a vehicle 300, the shooting angle of the image capturing unit 110 needs to be parallel with the road surface (as shown in FIG. 3) and maintain in this state. When the angle between the image capturing unit 110 and the road surface deflects, the processing unit 140 selects a corresponding shooting angle logic table from the storage unit 130 according to the angle information and generates an actuation signal, so as to adjust the shooting angle of the image capturing unit 110 and a direction of the photosensitive module 150 (as shown in FIG. 4).

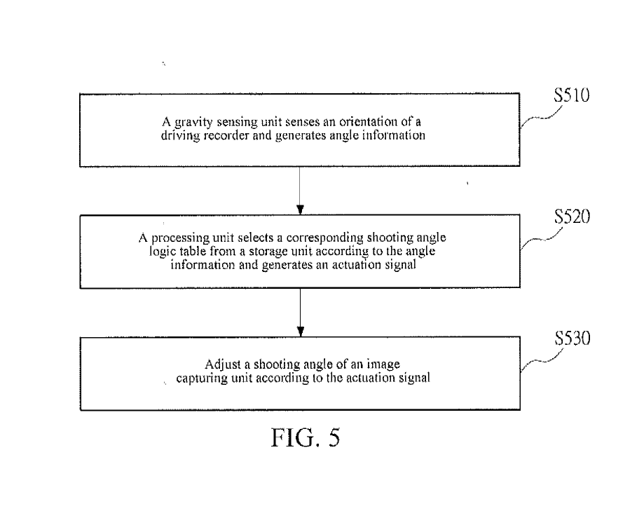

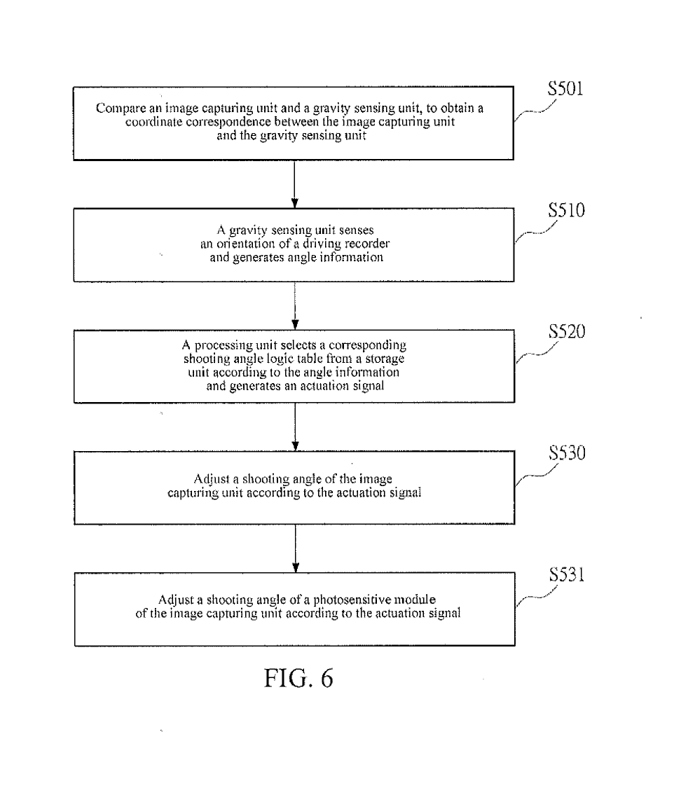

Referring to FIG. 5 and FIG. 6 together, FIG. 5 and FIG. 6 are flowcharts illustrating a shooting posture correction method of a driving recorder. The correction method of a driving recorder capable of assisting in correcting a shooting posture is applicable to a driving recorder, where the driving recorder at least includes a storage unit for storing shooting angle logic tables to correspond to a variety of orientations of the driving recorder. The correction method includes the following steps: first, comparing an image capturing unit with a gravity sensing unit, to obtain a coordinate correspondence between the image capturing unit and the gravity sensing unit (Step S501); next, sensing, by the gravity sensing unit, an orientation of the driving recorder and generating angle information (Step S510), and selecting, by a processing unit, a corresponding shooting angle logic table from the storage unit according to the angle information and generating an actuation signal (Step S520); and finally, according to the actuation signal, adjusting a shooting angle of the image capturing unit (Step S530) and adjusting a shooting angle of a photosensitive module of the image capturing unit (Step S531).

The present invention has been disclosed through preferred embodiments, but is not intended to be limited thereto. Various variations, modifications and equivalent replacements made by persons skilled in the art without departing from the spirit and scope of the present invention fall within the protection scope of the present invention.

What is claimed is:

1. A driving recorder capable of assisting in correcting a shooting posture, comprising:
an image capturing unit;
a gravity sensing unit, for sensing an orientation of the driving recorder and generating angle information;
a storage unit, for storing shooting angle logic tables to correspond to a variety of orientations of the driving recorder; and
a processing unit, for selecting a corresponding shooting angle logic table from the storage unit according to the angle information, and generating an actuation signal, so as to adjust a shooting angle of the image capturing unit.

2. The driving recorder capable of assisting in correcting a shooting posture according to claim 1, wherein the image capturing unit further comprises a photosensitive module.

3. The driving recorder capable of assisting in correcting a shooting posture according to claim 2, wherein the photosensitive module adjusts a direction according to data obtained by the gravity sensing unit after measurement.

4. The driving recorder capable of assisting in correcting a shooting posture according to claim 1, wherein the image capturing unit and the gravity sensing unit have a coordinate correspondence therebetween.

5. The driving recorder capable of assisting in correcting a shooting posture according to claim 1, wherein the shooting angle of the image capturing unit is parallel with a road surface.

6. A correction method of a driving recorder capable of assisting in correcting a shooting posture, applicable to a driving recorder, wherein the driving recorder at least comprises a storage unit for storing shooting angle logic tables to correspond to a variety of orientations of the driving recorder, the correction method comprising:
sensing, by a gravity sensing unit, an orientation of the driving recorder and generating angle information;
selecting, by a processing unit, a corresponding shooting angle logic table from the storage unit according to the angle information and generating an actuation signal; and
adjusting a shooting angle of an image capturing unit according to the actuation signal.

7. The correction method of a driving recorder capable of assisting in correcting a shooting posture according to claim 6, wherein the step of adjusting a shooting angle of an image capturing unit according to the actuation signal further comprises;
adjusting a shooting angle of a photosensitive module of the image capturing unit according to the actuation signal.

8. The correction method of a driving recorder capable of assisting in correcting a shooting posture according to claim 7, further comprising:
adjusting a direction of the photosensitive module according to data obtained by the gravity sensing unit after measurement.

9. The correction method of a driving recorder capable of assisting in correcting a shooting posture according to claim 6, further comprising:
comparing the image capturing unit with the gravity sensing unit to obtain a coordinate correspondence between the image capturing unit and the gravity sensing unit.
